(19) United States
(12) Patent Application Publication
(10) Pub. No.: US 2007/0180067 A1
(43) Pub. Date: Aug. 2, 2007

(54) Method and computer for configuration of a communication node

(76) Inventor: Wolfgang Schiffer, Herzogenrath (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/588,706

(22) PCT Filed: May 31, 2005
(86) PCT No.: PCT/EP05/52484

§ 371 Date: Aug. 8, 2006

(30) Foreign Application Priority Data
Jun. 3, 2004 (DE) 102004027126.7

(51) Int. Cl. G06F 15/177

(52) U.S. Cl. 709/220

(57) ABSTRACT

A method and a computer for configuration of a communication node, by means of a communications application, installed on a computer are provided. Selectable instructions are thus displayed on a graphical user surface. At least one user address is represented by an element which may be moved on the graphical user surface, and the element is marked by a selection means, moved to a selected displayed instruction and opened. The communication address represented by the element is thus linked to the selected instruction and the communication node is configured by the communication application, whereby an operational command is generated by the communication application, using the communication address and the instruction associated therewith, which is transmitted to the communication node and used for configuration thereof.

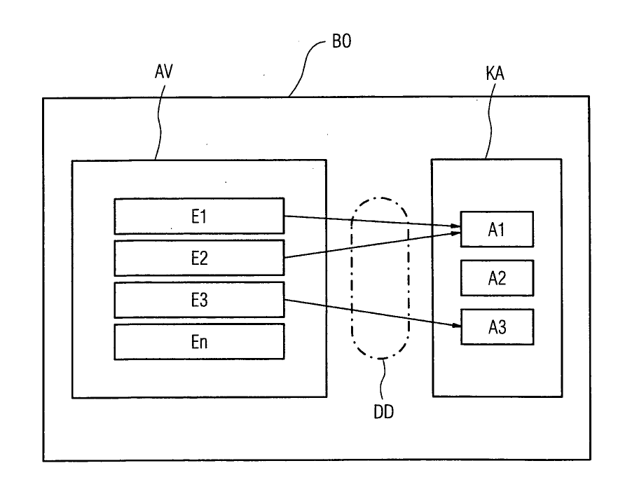

### CROSS REFERENCE TO RELATED APPLICATIONS

This application is the US National Stage of International Application No. PCT/EP2005/052484, filed May 31, 2005 and claims the benefit thereof. The International Application claims the benefits of German application No. 102004027126.7 DE filed Jun. 3, 2004, both of the applications are incorporated by reference herein in their entirety.

### FIELD OF INVENTION

The invention relates to a method and to a computer for configuring a communication node.

### BACKGROUND OF INVENTION

Messages or communication links arriving at communication nodes are processed or forwarded at these nodes using communication addresses. If the communication node used is a telephone installation (“switching system”), for example, an incoming telephone call or an incoming fax connection is switched to the desired terminal using a (direct dial) call number. Similarly, communication nodes which are intended for processing electronic messages (e-mail) forward the electronic messages to the associated recipient mailbox using the associated recipient communication addresses (e-mail addresses).

Commands (operational orders) can be input into the communication nodes and configure these communication nodes such that particular incoming messages or communication links are handled in a particular manner. By way of example, a configuration of this type may determine that an incoming communication link (telephone call, fax message) is forwarded to another communication terminal (“call diversion”), or else—in the case of e-mail systems—that an incoming e-mail message from a particular sender (sender communication address) needs to be diverted or needs to be answered in a particular manner (“e-mail forwarding”, auto reply”).

For such configuration of the communication nodes, appropriate operational orders are created by a user and are transmitted to the relevant communication nodes. In the case of the telephone switching systems, the operational orders can be input by inputting a series of digits on a communication terminal, for example. Another way is to use computer-aided user interfaces (“administration tools”) which, by way of example, as part of a CTI (Computer Telephony Integration) application, allow the editing of lists which are stored in the communication node (switching system) and which determine the manner in which an incoming communication link from a particular caller needs to be processed, for example.

The e-mail systems can also be configured using operational orders, with the e-mail systems also using lists or similar data structures to store statements describing the configuration. To create or edit such lists (and hence the configuration), the auxiliary means used are frequently “rule assistants” (wizards) in which a program-controlled interrogation operation asks a user for the information required for configuration. In this case, by way of example, a user may provide a definition that the electronic messages from a particular sender need to be stored in a specific mailbox or in a specific folder. This information is converted by the “wizard” into an operational order, that is to say into a series of commands which enters (configures) the relevant order and its parameters in a list (association list) for the communication node.

### SUMMARY OF INVENTION

A drawback found in the case of the known methods and arrangements for configuring communication nodes is that inputting and changing the operational orders are often complicated and time-consuming. Particularly for novice users, configuring the communication nodes is a very complex, time-consuming operation.

It is therefore an object of the present invention to simplify the configuration of communication nodes, so that rapid, simple and reliable operability is provided.

The object is achieved for the method and for the computer by the features of the independent claims.

The solution provides a method for configuring a communication node, where the communication node is configured using operational orders from a communication application installed on a computer, and where configuration is effected by logically combining at least one communication address with at least one of a plurality of selectable instructions. In this context, the selectable instructions are visually displayed on the user interface, the at least one communication address is shown by an element which can be moved on the graphical user interface, the element is moved by a selection means to a selected instance of the visually displayed instructions and is enabled there, the at least one communication address shown by the element is logically combined with the selected instruction, and the communication application configures the communication node by virtue of the communication application using the at least one communication address and the instruction logically combined therewith to create an operational order, transmitting it to the communication node and using it to configure the latter. This method configures the communication node by moving a graphical element, for example an icon or a name, on the graphical user interface in simple fashion (“drag'n'drop”). In this case, moving objects on a graphical user interface is a customary control operation, which means that use of the method is very simple and intuitive to learn and implement. The fact that the user performs just one control step means that configuration is particularly easy to carry out.

The object is also achieved by a computer for configuring a communication node, where the computer is equipped with an installed communication application and is set up to transmit operational orders to the communication node, the installed communication application being designed to logically combine at least one communication address with instructions and being set up to convert the logic combination into one of the operational orders. In this context, the computer is equipped with a graphical user interface for visually displaying the executable instructions, the user interface is set up to show at least one communication address using an element which can be moved on the graphical user interface, the element can be moved by a selection means to a selected instance of the visually displayed instructions and can be enabled there, the installed communication application is set up to logically combine the at least one communication address shown by the element with the selected instruction, and the communication application is designed to create the operational order using the logic combination and to transmit the operational order to the communication node. The computer equipped in this manner means that configuration of the communication node can be achieved in a simple, rapid, reliable and intuitively learnable manner.

The method and the inventive computer is advantageously refined further by the features of the dependent claims

The method makes it a particularly simple manner to carry out the most frequently performed configurations of communication nodes by virtue of the instruction determining the treatment of at least one communication link and/or message arriving in the future. This covers particularly important operational orders by virtue of the selectable instruction used being call forwarding, e-mail forwarding, creation of an automated response and/or a block on the at least one communication link and/or message arriving in the future.

It becomes even easier to carry out the method and hence to use the relevant computer if the element used is a displayed communication address, a displayed entry in an address directory or an electronic document containing at least one communication address. In this context, the document is advantageously represented by a graphical, movable symbol.

Control which is familiar to most users is achieved by virtue of the selection means used being a mouse pointer of a computer mouse. In this case, the selectable instructions are advantageously formed by logos, buttons or symbols; the same applies to the elements which are to be moved. In this context, the instructions may alternatively also be in the form of movable elements which are then “dragged” to the communication address (or communication addresses) by means of “drag'n'drop”.

Changing or revoking operational orders (instructions, commands) which have been input requires no further, separate instructions or method steps if the element is moved by the selection means to the selected visually displayed instructions again and is enabled there, with the logic combination between the communication address shown by the element and the selected instruction being cancelled and the communication application configuring the communication node again by virtue of the communication application using the cancelled logic combination to create a further operational instruction and transmitting to the communication node.

### BRIEF DESCRIPTION OF THE DRAWING

Exemplary embodiments of the inventive method are explained below with reference to the drawing and serve at the same to explain an exemplary embodiment of a computer based on the invention. In this case, the single FIGURE shows the user interface of a computer on which a communication application and an address directory are arranged in display windows.

### DETAILED DESCRIPTION OF INVENTION

The FIGURE shows the graphical user interface BO of a computer (not shown) on which the display windows for an address directory AV and for a communication application KA are displayed. The programs, objects, elements etc. displayed on the user interface BO, that is to say including the address directory AV and the communication application KA, are essentially controlled by a graphical selection means, in this case using the mouse pointer of a compute mouse. The computer has a plurality of communication nodes, likewise not shown, connected to it, with the communication nodes being controlled or configured by the communication application KA. In this case, the communication nodes are configured using operational orders, that is to say commands, which are transmitted from the communication application KA to the respective communication node which is to be configured.

The text below describes the configuration of one of the communication nodes by way of example, this communication node which is to be configured being a “gatekeeper” in a voice data communication arrangement (VoIP network; VoIP=Voice over Internet Protocol). The aim of configuration is to forward the communication links arriving at the communication node (e.g. telephone calls) from a particular caller to the mobile radio port of a user of the computer. To this end, the communication node is configured such that the communication addresses (call number information) of incoming communication links (“CLIP”=Calling Line Presentation) are evaluated and, in the event of a match with a previously defined communication address (call number), the appropriate action is executed, that is to say in this case the call forwarding to the predefined mobile radio port. It goes without saying that it is also possible to configure other functions in the manner described below.

The address directory AV lists a plurality of entries E1, E2, E3, En which are respectively logically combined with an address data record in an address database on which the address directory AV is based. The visual display of each of the entries E1, E2, E3, En comprises an address name which can be moved and enabled using the mouse pointer (selection means). This operation is also called “drag'n'drop” DD. It goes without saying that symbols (“icons”) or other elements may also be used for the visual display. The window containing the communication application KA shows various instructions A1, A2, A3 which are visually displayed in symbol form, with the instruction A1 in the present exemplary embodiment relating to the call forwarding to a predefined mobile radio port associated with the user, the instruction A2 relating to the block (“rejection”) on incoming communication links and messages, and finally the instruction A3 relating to the forwarding of incoming e-mail messages to a predefined e-mail inbox associated with a third person.

To configure the communication node (that is to say in this case, the gatekeeper), the user uses the mouse pointer to drag the entry E1 from the address directory AV to the selected instruction A1 in the communication application KA and, there, enables the movable element, namely the entry E1 (address name), on the symbol for the instruction A1 (for example by releasing a mouse button). As a result, the computer program on which the communication application KA is based recognizes the logic combination between the entry E1 and the instruction A1, and the communication application KA retrieves the associated address data record in the entry E1 from the address database and analyzes it. During the analysis, it is revealed that the entry E1 has an item of call number information (“telephone number”) and an e-mail address associated with it as communication addresses. Since the instruction A1 is an instruction to forward communication links, that is to say telephone calls and fax messages, the communication application KA logically combines the call number information associated with the entry E1, as communication address, with the instruction A1. On the basis of this logic combination, the communication application KA now creates an operational order, that is to say a series of commands which comprises not only the “call forwarding” instruction but also the logically combined communication address (call number information from entry E1) as a parameter and the call number of the user's mobile radio port as “destination address”. This operational order is sent from the communication application KA to the connected communication node (gatekeeper) via the computer's own communication means (e.g. network interface), as a result of which the communication node is configured in the desired manner. This configuration which is performed is also recorded in a memory associated with the communication application KA.

To reverse the configuration of the communication node which has been performed in this manner, that is to say in order to terminate the call forwarding to the mobile radio port, the user performs the same “drag'n'drop” action DD again. On account of the information recorded in the memory for the communication application KA, the communication application KA recognizes that the logic combination between the entry E1 or a communication address correlated to the entry E1 and the instruction A1 has already been configured at the communication node. The communication application KA therefore prompts display of a report window on the user interface BO, which notifies the user that appropriate configuration already exists, and a check is performed to determine whether this configuration is to be maintained or cancelled. If the user decides to cancel the configuration at this point, the communication application KA creates a new operational order which is transmitted to the communication node and which results in the desired change to the configuration of the communication node.

The text below uses a further exemplary embodiment to describe the configuration of a further communication node. The communication node to be configured in this case is a server for processing electronic mail, known as an e-mail server. The e-mail server is configured using the same communication application KA as is also used to configure the gatekeeper. The communication application KA is a “unified messaging system”, in which various communication services, for example, telephone answering machine, e-mail service and fax service, are offered to the user in combination using a common user interface (display window).

In a similar manner to the practice in the exemplary embodiment outlined above, the user uses the “drag'n'drop” DD method to drag a document shown as a symbol on the user interface BO to the instruction A3 in the communication application KA. In this context, the document shown as a symbol is a text document containing a letter. This text document is opened by the communication application KA using a word processing program installed on the computer and is searched for communication addresses which can be used with the instruction A3. Since the instruction A3 is an instruction for e-mail forwarding, the communication application KA searches the letter for character strings in the format “XYZ@abc.de” and in so doing finds an e-mail address.

In cases in which the communication application KA finds a plurality of suitable communication addresses, the communication application KA presents the communication addresses found to the user for selection in a screen window.

The communication address found is then logically combined with the instruction A3 and is converted into an appropriate operational order for the communication node e-mail server. The operational order is then sent to the communication node, where it is used to configure the communication node. As a result, the communication node is now configured such that all incoming messages (e-mails) are forwarded to the communication address found. Alternatively, the instruction A3 may also be in a form such that only those incoming messages which have the communication address found as sender address are forwarded. In that case, however, the destination address (e-mail address) for the messages which are to be forwarded needs to be defined in the communication application KA.

Alternatively or in addition to the “drag'n'drop” DD method described above, the communication application may also be set such that the symbols or buttons representing the instructions A1, A2, A3 can be “dragged” to the entries E1, E2, E3, En, as a result of which the configuration of the communication nodes is likewise started.

The communication application KA is—as already described—in a form such that suitable communication addresses are ascertained by automatically accessing address databases, for example the address database on which the address directory AV is based. If this involves the “drag'n'drop” DD method, for example, being used to drag an e-mail message which does not comprise any call number information to the instruction A1, the communication application KA accesses the address database for the address directory AV in order to use the e-mail address contained in the e-mail message to read an entry associated with the same user in the database on which the address directory AV is based and to obtain the call number information therefrom. This call number information is then logically combined with the selected instruction A1, as a result of which a new operational order is generated and is transmitted to the communication node (gatekeeper) for configuration.

1.-8. (canceled)

9. A method for configuring a communication node, comprising:
configuring the communication node via an operational order from a communication application installed on a computer, the configuration effected by logically combining a communication address with at least one of a plurality of selectable instructions;
displaying the selectable instructions on a graphical user interface;
displaying the communication address via a movable element on the graphical user interface;
moving the element to one of the plurality of selectable instructions, whereby the one of the plurality of selectable instructions is a selected instruction;
logically combining the communication address of the moved element with the selected instruction;
creating the configuration order using the combined address and instruction; and
transmitting the configuration order to the communication node to configure the communication node.

10. The method according to claim 9, wherein the selected instruction determines the treatment of a communication link or a message arriving in the future.

11. The method according to claim 10, wherein the selected instruction is selected from the group consisting of call forwarding, e-mail forwarding, creation of an automated response, a block on the communication link, a block on the message and combinations thereof.

12. The method according to claim 11, further comprising:
repeating the moving of the element;
canceling the combination between the address and selected instruction;
creating a new configuration order using the resulting from the cancel; and
transmitting the new configuration order to the communication node to configure the communication node.

13. The method according to claim 9, wherein the element is selected from the group consisting of a displayed communication address, a displayed entry in an address directory and a document containing at least one communication address.

14. The method according to claim 9, wherein the element is selected via a mouse pointer of a computer mouse.

15. The method according to claim 9, wherein the plurality of selectable instructions are formed by logos, buttons or symbols.

16. The method according to claim 9, further comprising:
repeating the moving of the element;
canceling the combination between the address and selected instruction;
creating a new configuration order using a result from the cancel; and
transmitting the new configuration order to the communication node to configure the communication node.

17. A computer for configuring a communication node, comprising:
a graphical user interface for displaying the plurality of selectable instructions and for displaying a moveable element, the moveable element visually representing the communication address;
a selection mechanism for moving the element to a selected an instance of the selectable instructions; and
an installed communication application comprising:
a combination mechanism for logically combining the communication address of the moved element with the selected instruction,
an operational order created via the combined address and instruction, and
a transmission mechanism for transmitting the operational order to the communication node in order to configure the communication node.

18. The computer according to claim 17, wherein the selected instruction determines the treatment of a communication link or a message arriving in the future.

19. The computer according to claim 18, wherein the selected instruction is selected from the group consisting of call forwarding, e-mail forwarding, creation of an automated response, a block on the communication link, a block on the message and combinations thereof.

20. The computer according to claim 17, wherein the element is selected from the group consisting of a displayed communication address, a displayed entry in an address directory and a document containing at least one communication address.

21. The computer according to claim 17, wherein selection mechanism is a mouse pointer of a computer mouse.

22. The computer according to claim 17,
wherein the selection mechanism is used to repeat the moving of the element, and
wherein the combination between the address and selected instruction is canceled as a result of the repeated move.

23. The computer according to claim 22,
wherein a new configuration order is created using a result from the cancel, and
wherein the new configuration order is transmitted to the communication node to configure the communication node.
